(19) United States
(12) Patent Application Publication
(10) Pub. No.: US 2010/0018401 A1
(43) Pub. Date: Jan. 28, 2010

(54) DEVICE FOR THE PREPARATION OF A BEVERAGE

(75) Inventor: Steffen Weinreich, Minden (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/507,291

(22) Filed: Jul. 22, 2009

(30) Foreign Application Priority Data
Jul. 23, 2008 (DE) 20 2008 009 855.6

(51) Int. Cl. A47J 31/40; A47J 31/44

(52) U.S. Cl. 99/280; 99/300

(57) ABSTRACT

A device for preparing a beverage, in particular coffee, including a reservoir containing a fluid, an outlet opening through which the fluid is pumped from the reservoir to a brewing chamber, and a valve to close off the outlet opening and to adjust a brewing pressure of the brewing chamber in dependence of the beverage to be prepared. The valve is coupled to a leaf spring having an adjustable spring force in order to close off the valve.

### CROSS-REFERENCE TO RELATED APPLICATION

This application claims the priority of German Patent Document No. 20 2008 009 855.6, filed on Jul. 23, 2008, the subject matter of which is incorporated herein by reference.

### BACKGROUND OF THE INVENTION

The present invention relates to a device for the preparation of a beverage, in particular coffee, comprising a reservoir that contains a liquid which can be pumped with the aid of a pump to a brewing chamber, wherein the brewing chamber can be closed off by means of a valve and wherein the brewing pressure can be adjusted depending on the beverage to be prepared.

Automatic coffee makers are generally known, which pump hot water with the aid of a pumping mechanism to the brewing chamber, wherein the brewing pressure corresponds to the counter pressure generated at the valve on the brewing chamber. All beverages are furthermore prepared with the same brewing pressure. However, some hot beverages require a different brewing pressure for the preparation. For example filtered coffee does not require any brewing pressure while a pressure of 1 to 3 bars is needed to prepare coffee with a frothed topping, and espresso must be prepared with a pressure of 8 to 9 bar.

### SUMMARY

It is therefore an object of the present invention to create a device for preparing a beverage which uses simple means to make available different brewing pressures.

The above and other objects are accomplished according to one aspect of the invention wherein there is provided a device for preparing a beverage, in particular coffee, including a reservoir containing a fluid, an outlet opening through which the fluid is pumped from the reservoir to a brewing chamber, and a valve to close off the outlet opening and to adjust a brewing pressure of the brewing chamber in dependence of the beverage to be prepared. The valve is coupled to a leaf spring having an adjustable spring force in order to close off the valve.

In an embodiment, the brewing chamber can be closed off with the aid of a valve that is connected to a leaf spring, for which the spring force can be adjusted for the closing of the valve. The closing force of the valve can thus be changed with simple means to change the brewing pressure within the brewing chamber before a brewing operation. As a result, it is possible to prepare high-quality filtered coffee, coffee with a frothed topping, or espresso, depending on which beverage is to be prepared with the device.

In another embodiment, a slider or sliding valve is provided for adjusting the spring force. A slider of this type can be operated easily and requires only a few components for adjusting the brewing pressure. The slider may be arranged between the brewing chamber and the outlet for the brewed beverage, which makes it possible to keep the lines short.

In a further embodiment, to ensure an optimum quality for the frothed topping or cream and to prevent liquid from leaving the brewing chamber, a sealing element for closing off a flow-through line may be affixed to the leaf spring. This sealing element can also be a component of the valve to ensure a secure sealing.

In another embodiment, for an easy adjustment, the slider can be guided in a linear direction along the leaf spring, wherein the slider can be adjusted manually or with the aid of a drive. A control may be provided to detect the position of the slider, for example so that the brewing pressure can be indicated to the user with the aid of a display. The brewing pressure can be adjusted continuously in that case, for example, in the range between approximately 0 and 10 bar.

According to another embodiment, the slider may be embodied as a clamp that is used to adjust the length of the pivoting part of the leaf spring.

In a further embodiment, the valve can be secured in an opened position, so that the device can also be used to prepare beverages without pressure.

### BRIEF DESCRIPTION OF THE DRAWINGS

The present invention will be more readily understood from the following detailed description when read in conjunction with the accompanying drawings, in which:

FIG. 1 is a front-top perspective view of a lower section of a brewing chamber according to the invention;

FIG. 2 is a front-bottom perspective view of a brewing chamber according to FIG. 1;

FIG. 3 is a sectional view through the brewing chamber including an additional sealing element; and

FIG. 4 is a sectional view through the brewing chamber as shown in FIGS. 2 and 3, without the sealing element and with the valve opened.

### DETAILED DESCRIPTION

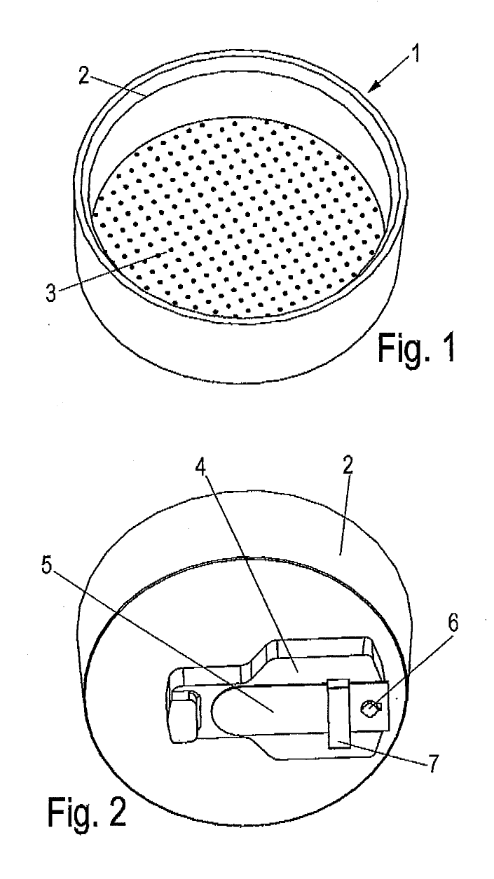

Referring to FIGS. 1-4, there is shown an embodiment of a device for preparing a beverage, in particular coffee, which comprises a mechanism for pumping liquid to a brewing chamber 1. The brewing chamber 1, shown herein, comprises a housing 2, wherein only the lower portion of the brewing chamber 1 is shown. The brewing chamber 1 is designed to be closed at the top, so that a beverage can be brewed under pressure.

The brewing chamber 1 is provided with a screen 3 or with filter paper on the inside, onto which coffee grounds can be placed, wherein capsules or pods can optionally also be used in the brewing chamber 1.

A leaf spring 5 is attached to a bottom 4 of the brewing chamber, such that it is secured on one side to a trunnion 6 and can rotate. As shown in FIGS. 2-4, a slider 7 may be moved in a linear direction along the leaf spring 5. The length of the pivoting section of the leaf spring 5 may be adjusted with the aid of the slider 7.

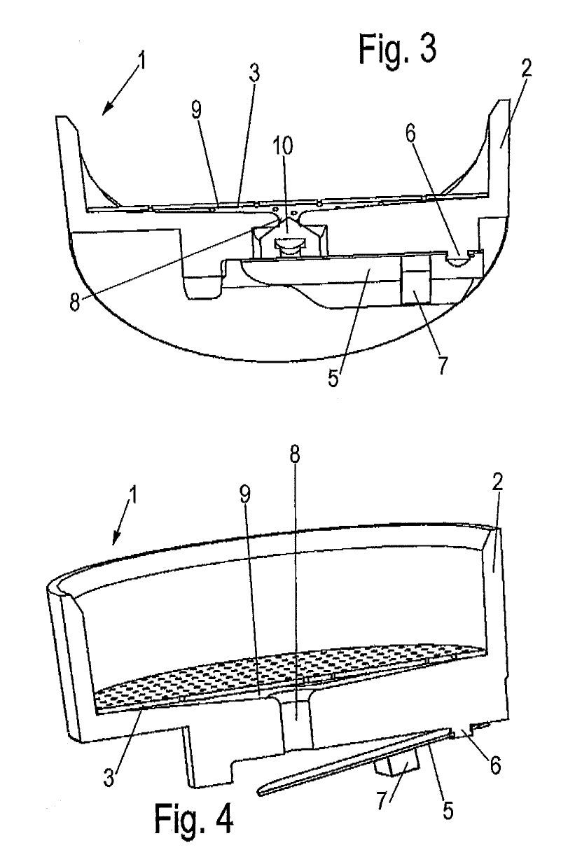

FIG. 3 is a sectional view through the brewing chamber 1, wherein a plate-shaped screen 3 is provided on the bottom of the brewing chamber 1. The bottom of the housing 2 surrounding the brewing chamber declines toward the center region, so that a gap 9 is provided between the screen 3 and the bottom of the housing 2. An outlet opening 8 with a valve head 10 is provided at the lowest point of the bottom for the housing 2. The valve head 10 closes off the opening 8 on the brewing chamber 1, wherein the valve head 10 is affixed to one end section of the leaf spring 5.

The plate-shaped leaf spring 5 consists of an elastic material, in particular a metal, and is secured on one side so that it can rotate. The length of the pivoting portion of the leaf spring 5 with the valve head 10 may be adjusted by guiding a slider 7 along the spring leaf 5, as shown in FIG. 3. The slider 7 may be embodied in the manner of a clamp and encompasses the leaf spring 5 on the underside. Depending on the position of the slider 7, a different pressure must be used in the brewing chamber 1 for pushing the valve head 10 from the outlet opening 8, thereby releasing the fluid. The valve head 10 can be composed of an elastic material or can be coated therewith, wherein the valve head 10 is secured to one end section of the leaf spring 5.

In FIG. 3, the valve head 10 that projects into the opening 8 in the bottom of the housing 2 is arranged on the leaf spring 5. Alternatively, a flat leaf spring 5 can also be used, as shown in FIG. 4, which can be pushed against the outlet opening 8 and thus seal the opening. The leaf spring 5 can furthermore also be provided with a coating in the region of the outlet opening 8.

FIG. 4 shows the brewing chamber 1 without the valve head 10 on the leaf spring 5. The leaf spring 5 is in the opened position, in which the outlet opening 8 on the housing 2 is exposed. This position ensures that a brewing operation can occur even in the state without pressure, meaning when the valve head 10 or the leaf spring 5 do not close off the outlet opening 8, which is particularly important for the production of filtered coffee.

The slider 7 can be displaced either manually or with the aid of a drive along the leaf spring 5. A sensor can furthermore be provided to detect the position of the slider 7 and then transmit a signal to the control to indicate which brewing pressure is necessary in the brewing chamber 1 for releasing a beverage. Corresponding information could also be indicated with the aid of a display panel.

It will be understood that the above description of the present invention is susceptible to various modifications, changes and adaptations, and the same are intended to be comprehended within the meaning and range of equivalents of the appended claims.

What is claimed is:

1. A device for preparing a beverage, in particular coffee, comprising:
a reservoir containing a fluid;
an outlet opening through which the fluid is pumped from the reservoir to a brewing chamber; and
a valve to close off the outlet opening and to adjust a brewing pressure of the brewing chamber in dependence of the beverage to be prepared, wherein the valve is coupled to a leaf spring having an adjustable spring force in order to close off the valve.

2. The device according to claim 1, further including a slider coupled to and moveable along the spring leaf to adjust a spring force of the leaf spring.

3. The device according to claim 1, wherein the valve is arranged between the brewing chamber and the outlet opening.

4. The device according to claim 1, further comprising a sealing element affixed to the leaf spring to close off a flow-through line at the outlet opening.

5. The device according to claim 2, wherein the slider is moveable in linear direction along the leaf spring.

6. The device according to claim 2, wherein the slider is adjustable manually.

7. The device according to claim 2, further comprising a drive coupled to the slider to adjust a position of the slider.

8. The device according to claim 2, further comprising a control to detect a position of the slider.

9. The device according to claim 1, wherein the slider is adjustable to adjust the spring force of the leaf spring to vary the brewing pressure between 0 and 10 bar.

10. The device according to claim 1, wherein the slider is continuously adjustable to provide an infinite adjustment of the brewing pressure.

11. The device according to claim 2, wherein the slider has predetermined positions to correlate with the predetermined brewing pressures.

12. The device according to claim 2, wherein the slider comprises a clamp moveably mounted to adjust a length of a pivoting section of the leaf spring.

13. The device according to claim 12, wherein the clamp is moveably arranged along the brewing chamber.

14. The device according to claim 1, wherein the valve is securable in an open position for preparation of a beverage without pressure.
